(19) United States
(12) Patent Application Publication
(10) Pub. No.: US 2026/0346682 A1
(43) Pub. Date: Nov. 5, 2026

(54) HEATING ASSEMBLY AND HEATING DEVICE FOR A VEHICLE

(71) Applicant: Webasto SE, Stockdorf (DE)

(72) Inventors: Mustafa Yurt, Stockdorf (DE); Peter Neidenberger, Stockdorf (DE)

(21) Appl. No.: 19/124,722

(22) PCT Filed: Oct. 27, 2023
(86) PCT No.: PCT/EP2023/080054

§ 371 Date: Apr. 25, 2025

(30) Foreign Application Priority Data
Oct. 27, 2022 (DE) 102022128489.1

(51) Int. Cl. B60H 1/22; B60H 1/00

(52) U.S. Cl. CPC B60H 1/2221; B60H 1/00878; B60H 2001/2278

(57) ABSTRACT

A heating assembly for a vehicle, comprising a heat exchanger that has a support body for an electric heating element, with the support body having a heating side and, opposite, a heat transfer side, at least one electric heating element which is attached to the heating side of the support body, a control unit for the at least one heating element, and at least one electric connection line for supplying power to the heating element, the support body having at least one through-opening from the heat transfer side to the heating side, through which the connection line extends.

### CROSS-REFERENCE TO RELATED APPLICATIONS

This application is a 35 U.S.C. § 371 National Stage Entry of International Application No. PCT/EP2023/080054 filed Oct. 27, 2023, which claims priority from German national patent applications No. 10 2022 128 489.1, filed with the German Patent and Trademark Office on Oct. 27, 2022, the disclosures of all of which are incorporated herein by reference in their entireties and for all purposes.

### TECHNICAL FIELD

The invention relates to a heating assembly and a heating device, preferably a high-voltage heating device, for a vehicle, in particular for an electric or hybrid vehicle.

### TECHNICAL BACKGROUND

Heating devices are employed in vehicles for heating the interior, or for heating components. For application in electric or hybrid vehicles, which generate less waste heat than a conventional vehicle having a combustion engine, electric heating devices are subject to particular requirements. Air or water are primarily employed as heat transfer media.

DE 102 16 010 A1 discloses an electric heating device having a control apparatus for controlling heating elements of a heating unit. An electrical contact between contacts on the control apparatus and contacts of the heating unit is established by means of a solid connection, in particular by means of screws or rivets, in order to prevent any release of contacting in response to vibrations.

WO 2013/171079 A1 describes an electric vehicle heater, in particular for vehicles having a hybrid drive or having an electric drive, having a support body which comprises a ceramic substrate and which is thermally coupled to a heat-exchanger. The support body is subdivided into two mutually adjacent heating zones, having at least one heating element. An actuation unit is provided for the mutually independent actuation of the heating elements, and is arranged in a region of the support body which is positioned outside the heating zones. The two heating zones, and an actuation zone, are sequentially arranged in a longitudinal direction of extension of the ceramic substrate.

DE 10 2019 214 566 A1 relates to an electric heating assembly having heating elements which are at least arranged on two opposing sides of a coolant housing, and a curved three-part circuit board. The coolant housing is arranged between two opposing marginal sub-boards, and the power supply terminals of the heating elements and terminals of the marginal sub-boards are in electrical contact. A logic circuit is arranged on the central sub-board.

WO 2019/169501 A1 relates to a heat-exchanger having an electric heating element, which comprises an electrically insulating dielectric base layer and an electric heating resistance layer on the base layer. A conductive layer is positioned in direct contact with the heating resistance layer and below the longitudinal edges of the heating resistance layer, between the heating resistance layer and the dielectric base layer. The conductive layer forms a connection to an electric current source.

### SUMMARY

For vehicles having a high-voltage on board power supply system, high-voltage heating devices for the electric heating of a water circuit by means of a heat transfer device (heat-exchanger) are known. Heating elements based upon a layer heating technology convert a direct or alternating electric current into heat with a high degree of efficiency. In existing heating devices, the heating elements and the electrical contacts thereof are arranged on the same side of the heat-exchanger. In many cases, these heating devices comprise control devices, the housing of which outwardly encloses both sides of the heat-exchanger. One disadvantage is the limited flexibility of the housing design.

Proceeding from this prior art, the object of the present invention is the provision of a heating device for a vehicle, in particular for an electric or hybrid vehicle, which enables a structurally simple contacting of a heating element and the greatest possible flexibility of the housing design. It is moreover intended that manufacture should be as cost effective as possible.

This object is solved by a heating assembly according to claim 1, and by a heating device according to claim 14.

In particular, the above-mentioned object is fulfilled by a heating assembly for a vehicle, in particular for an electric or hybrid vehicle, comprising
a heat-exchanger, having a support body for an in particular planar electric heating element, wherein the particularly plate-type support body has a heating side and a heat transfer side, which is arranged opposite thereto;
at least one electric heating element, preferably a layer heating element, which is fitted to the heating side of the support body;
a control unit for the at least one heating element; and
at least one electric connection line, which is connected to the control unit, for supplying power to the heating element,
wherein the support body comprises at least one through-opening from the heat transfer side to the heating side, through which the connection line extends.

By means of the heating assembly according to the invention, the electrical connection of a heating element with the control unit can be arranged on the heat transfer side, and thus on the opposing (other) side to the heating side, having the heating element. In comparison with the prior art, the electrical connection of the heating element is displaced by means of the control unit to the side which is averted from the heating element. A spatial separation of the control unit from the heating element is thus achieved. A high degree of flexibility for the configuration of the housing of the control unit is provided as a result. Contacts for the control unit, in particular for the contact regions of the housing of the control unit (control unit housing) and the contact on a control board, are thus more easily accessible. As a result, a control unit housing and a housing of the heat-exchanger (heat-exchanger housing), in accordance with spatial requirements in force, for example dictated by the space occupied by further vehicle components, can be configured in a more unrestricted, and preferably more cost-effective manner. In particular, the control unit housing and/or the heat-exchanger housing can be designed as (a) self-contained closed unit(s), within the meaning of a modular structure. Construction of the interface between the control unit and the heat-exchanger is significantly simplified. Hereinafter, the control unit housing is also described as a first module housing, and the heat-exchanger housing, in combination with a housing cover for the coverage of heating elements and the associated power circuit components, is also described as a second module housing.

The support body, in particular, is a component of a heat-exchanger housing. The through-opening may (only) penetrate the support body, or may (also) penetrate further elements of the heat-exchanger, in particular the (entire) heat-exchanger housing, from one side to the other. The through-opening is preferably entirely laterally enclosed (circumscribed), but may also be partially laterally open. The through-opening can thus be understood as a cut-out in an edge region of the support body. In service, the heat transfer device (heat-exchanger), accommodates a throughflow, in particular, of a heat transfer medium, preferably of a fluid (coolant), such as water.

The (plate-type) support body extends, in particular (in a planar arrangement) along a primary plane of extension, is preferably configured as a (flat) support plate, and preferably assumes a rectangular basic shape. The support body, on the heating side, in particular comprises a planar heating surface, in particular in a heat transfer section, but preferably also in a connecting section. On the heat transfer side, in particular in the heat transfer section, the support body is not necessarily flat, but can be molded, for example, to form one or more flow ducts, or sections thereof. The support body (support plate) is preferably formed of aluminum.

One heating element or multiple heating elements may be provided which, in particular, are arranged next to one another in order to mutually form a planar heating core (heating surface). A heating element preferably comprises at least one heating conductor. The heating element, in particular, is solidly bonded to the support body. The (thin) heating element is preferably configured as a layer heating element, for example having a layer thickness of less than 1 mm, and is preferably (directly) bonded to the heating surface of the support body, in particular by adhesive bonding. A layer of an, in particular, electrically insulating adhesive can be applied in regions to the support body, in order to bond the heating element (directly) to the support body. The heating element can preferably comprise an, in particular electrically insulating support layer, further preferably of a ceramic material, to which the heating conductor is fitted.

The support layer can be a ceramic substrate, for example of Al₂O₃. The heating conductor can be applied to the support layer (ceramic substrate) by a screen printing method. The heating conductor can be embodied, for example, as a metal plating formed of a resistance alloy, which constitutes the corresponding heating resistor. Options for consideration include, inter alia, an iron-nickel alloy or a nickel-chromium alloy. An interruption of insulation enables the structuring of elongated printed conductors from the otherwise full-surface and subsequently stove-fired layer and can be executed, for example, as early as during application by means of a screen printing process. In consideration of aspects of the invention, this embodiment of a heating element is preferred.

The support layer is preferably bonded to the support body, further preferably by adhesive bonding. In particular, the support body comprises a connecting region for the (direct or indirect) fastening of the heating element, in which, preferably, an adhesive layer and/or a support layer of the heating element, preferably of a ceramic material, is arranged. The connecting region preferably corresponds (approximately) to the heat transfer section of the support body. A planar heating element has a large contact surface area for heat transfer, and is able to convert electric current into heat in an efficient manner.

The heating element or heating conductor layer may be implemented in various ways, and the invention is not limited to specific embodiments thereof. The heating element may also be comprised, for example, of thermally sprayed layers. For the purposes of production, atmospheric plasma spraying can be employed e.g. as a coating method. The resulting layer structure, commencing from the flat base (support body), is first an optional bonding surface, then a ceramic insulation, the actual heating conductor layer and, optionally, a capping layer or seal. The heating conductor layer may be structured by means of laser cutting or masking. The material of the heating conductor can be a material having linear or PTC resistance properties.

Polymer-based heating elements having PTC properties can also be considered. These can be heating elements formed of plastic films. Heating elements are generally comprised of an extruded or laminated polymer matrix, in which a heating conductor and a positive and negative electrode are embedded.

Moreover, the heating elements can also be ceramic heating elements having PTC properties (PTC thermistors).

The heat-exchanger may itself be formed e.g. of steel or aluminum, preferably in the form of a plate-type aluminum heat-exchanger.

A current source can be understood as a current infeed, i.e. the infeed of electric current associated with the application of an electric voltage (voltage potential), in particular by means of a connectable electric current source.

In one embodiment of the invention, the control unit, which is preferably configured for controlling multiple heating elements, comprises a control unit housing, in particular for accommodating a control board which forms a control device, and which is arranged on the heat transfer side of the support body. The control unit housing can be entirely, or at least essentially arranged on the heat transfer side of the support body. A connecting section of the control unit housing, having connection lines (printed conductors) accommodated therein and which, in particular, is configured as a plastic insert, can extend into the through-opening, or extend through the through-opening to the heating side. Multiple connection lines can be assigned to each heating element. The control unit can be configured for controlling, in particular, the current supply to a number (all) of the heating elements, and thus be understood as a superordinate controller of the heating assembly or of the heating device. The control unit housing, by the arrangement thereof on the heat transfer side, can be configured independently of the arrangement of heating elements and, optionally, of any power circuit components on the heating side. Electrical contacts for the heating elements are easily accessible on the heat transfer side. The length of a seal between the control unit housing and the heat-exchanger housing can be shortened.

In a further embodiment, the control unit and an inflow connection and/or an outflow connection for a heat transfer medium are arranged on the same side of the support body, preferably on the heat transfer side. As the heat-exchanger is constructed such that the inflow and/or outflow connections are arranged on the heat transfer side, which is averted from the heating elements, an as large as possible surface area of the support body can be employed, in particular with no spatial restrictions with respect to the arrangement of heating elements, for the transfer of heat. As a result, the structural space required for the heating assembly is reduced, whilst maintaining an equivalent heating capacity.

In a further embodiment, the support body comprises a heat transfer section in the region of the at least one heating element, and a connecting section which is external to the heat transfer section, wherein the at least one through-opening is formed in the connecting section. The connecting section is preferably arranged at the edge of the support body, preferably along the shorter lateral edge(s) of the at least one (rectangular) heating element. In the connecting section, in particular, the control unit housing is connected to the support body, or is fastened thereto. The heat transfer section preferably extends in a central (rectangular) region of the support body.

In a further embodiment, the heat-exchanger, on the heat transfer side of the support body, comprises at least one flow duct to accommodate a throughflow of a heat transfer medium. Flow ducts can be formed by the inner surfaces of the heat-exchanger housing, or by separate ducting structures, which are arranged in a void (coolant volume) of the heat-exchanger housing.

In a further embodiment, the heat-exchanger comprises a top cover which, in combination with the support body, forms a void for accommodating a throughflow of a heat transfer medium and which, in particular, forms at least one flow duct. One or more flow ducts can be formed by an (upper) surface of the support body and an (appropriate) opposing (lower) surface of a top cover of the heat-exchanger. In particular, in the heat transfer region of the support body, the top cover forms a cupped recess and, in particular, an inflow connection and/or an outflow connection for a heat transfer medium. In particular, the top cover and the support body form respective plate-type connecting sections which, in the region of the through-opening, at least overlap, in particular are (congruently) arranged one on top of the other, and are preferably (directly) mutually contiguous. A seal can be provided between the support body and the top cover.

In a further embodiment, the through-opening penetrates the top cover and the support body in the region of the connecting section of the support body. The support body and the top cover thus respectively each comprise a through-opening which coincide with each other.

In a further embodiment, on the heating side of the support body, at least one power switching unit is fitted for regulating the (electric and/or thermal) power of the heating element, wherein the power switching unit is preferably arranged between the through-opening and the heating element and, in particular, is electrically connected by means of the connection line. The power switching unit is preferably arranged on a power circuit board and, in particular, is designed for regulating the current flux through the heating element and/or for executing the reduction or interruption thereof with effect from a specific threshold. A power switching unit preferably comprises a temperature sensor, which is designed for monitoring the heating temperature of a heating element, or of the support body which is heated by means thereof, or of the heat transfer medium itself. A power switching unit can moreover comprise a signal processing unit which, in particular, is connected to the temperature sensor. As a result, any relaying of signals to the (superordinate) control unit is superfluous.

In a further embodiment, the power switching unit is connected to a temperature sensor which is arranged on the heating side of the support body, preferably on a circuit board of the power switching unit. In particular, the temperature sensor is designed for monitoring the temperature of a heating element, or of the support body which is heated by means thereof, or of the heat transfer medium itself. The thermal power output of heating elements can thus be controlled, and any overheating prevented.

In a further embodiment, multiple heating elements are fitted to the heating side of the support body and/or the support body comprises multiple through-openings, wherein one through-opening is preferably assigned to each heating element. As a result, the control device of each heating element may be connected in a separate manner. In particular, the heating elements are arranged next to one another, and in an (essentially) directly mutually contiguous manner, on the support body. By means of the control unit, the heating elements can be differently supplied with current or differently actuated wherein, in particular, the respective power output of the heating elements can be adjusted in a distinct manner.

In a further embodiment, a power switching unit is assigned to each through-opening, and is respectively connected by means of a connection line wherein, in particular, one power switching unit is assigned to each heating element. Preferably, (exactly) one through-opening is assigned to each heating element. Power switching units in turn (by means of printed conductors) can be electrically connected to heating elements wherein, preferably, each power switching unit is connected to (exactly) one heating element.

In a further embodiment, the primary plane of extension of the control board of the control unit is arranged at an angle of at least 45°, preferably of (approximately) 90°, to the primary plane of extension of the power switching unit and/or of the heating element. In particular, the primary plane of extension in the control board and/or of the power switching unit are defined by the plane of extension of the circuit board(s). The control board is preferably oriented perpendicularly to the primary plane of extension of the heating element (i.e. parallel to the heating surface). The structural area of the heating assembly can thus be reduced.

In a further embodiment, the connection line is embodied as a printed conductor which is partially enclosed in a plastic insert, in particular in the form of a bent punch grid, wherein the outer contour of the plastic insert is adapted to the inner contour of the through-opening. Connection lines in the form of printed conductors can preferably be embedded or overmolded in a plastic insert of the control unit housing. The plastic insert is preferably installed in an appropriately shaped connecting region of the control unit housing and, in the installed state, can extend into the through-opening.

In a further embodiment, the connection line incorporates a preferably two-fold angle wherein, in particular, line termination sections of the connection line extend in a parallel arrangement to the primary plane of extension of the preferably plate-type support body and, in particular, a mid-section of the line extends perpendicularly to the primary plane of extension of the support body. The cross-section of a connection line can thus be described as a Z-shape. The mid-section of the line preferably extends into the through-opening, or extends through the latter. In particular, a line termination section of the connection line which faces the control unit is routed in an (essentially) perpendicular direction to the control board, and is preferably (directly) connected thereto, e.g. by soldering and/or by press-fitting in a through-opening of the control board. In particular, a line termination section of the connection line which faces the power switching unit or the heating element is routed in an (essentially) parallel direction to the primary plane of extension thereof, and is preferably (directly) connected to a circuit board of the power switching unit (e.g. by soldering). By means of this shaping of the connection line, the point of contact for the heating elements, by means of the control unit, can be displaced to the heat transfer side in a structurally simple manner.

According to one exemplary embodiment, it is further provided that, in the control unit housing, also described hereinafter as the first module housing, for the distinction thereof from a second module housing, which is formed by the combination of the heat-exchanger on a heat transfer side and a housing cover for the heating side, at least one aperture is configured for the feedthrough of an electrical connection between the control device or control board in the first module housing of the control unit and a power switching unit for switching the heating element in the second module housing. In this case, one punch grid respectively can be arranged in the at least one aperture, together with the connection lines embedded in a common plastic insert, wherein the connection lines are connected with corresponding contacts on a control board which forms the control device.

The punch grids enable a robust electrical connection with the power switching elements which are arranged in the power switching units and/or with the heating elements, and enable a space-saving switchover of the sides of the heat-exchanger, as the fitting of the first module housing to the second module housing is preferably executed in an essentially perpendicular direction to a plane of the heat-exchanger, such that nozzle connections (fluid inlet, fluid outlet) and connector units (high-voltage, low-voltage), in an installed state in the vehicle, can be executed from the same side. In turn, however, this requires that the heating element(s) is (are) arranged on an opposing side of the planar heat-exchanger. The through-openings in the support body of the heat-exchanger therefore enable direct access, in the second module housing, to the side of the heating element(s).

Advantageously, the punch grid may extend through a through-opening which is formed in the support body, and through an aperture which is formed in the first module housing and is oriented with the through-opening, into an interior of the first module housing, where it is secured by means of at least one locating means, in particular by a locating pin, to the control board which forms the control device of the control unit.

For the mutual fixing of the two module housings, fastening means can be provided, in particular one or more screws, in order to secure the support body of the heat-exchanger or of a heat-exchanger module which is formed by the heat-exchanger and the heating elements, with the associated power switching unit or associated power switching units and the associated housing cover, to the first module housing, wherein the support body comprises the through-opening which is oriented with the at least one aperture in the first module housing, such that the punch grid extends through the through-opening of the support body, and contacts for the connection lines thereof are provided on the opposing side.

Between the mutually facing surfaces of the first module housing and the support body of the second module housing (of the heat-exchanger) a seal can be arranged, which seal encloses the at least one through-opening or the at least one aperture (and, in the event of multiple through-openings and associated apertures, executes the common enclosure thereof), and thus protects the interior of the first module housing, and an interior of the second module housing which accommodates the power switching unit and the heating element, against the ingress of moisture.

In particular, the above-mentioned object is also solved by a heating device, preferably a high-voltage heating device, for a vehicle, in particular for an electric or hybrid vehicle, which comprises at least one above-mentioned heating assembly according to the invention. The operating mode and advantages of the heating device proceed in an analogous manner to the structural and functional features described in conjunction with the heating assembly. A heating device of this type is particularly intended to be employed for the heating of a vehicle interior and/or of a vehicle component.

The heating elements of the heating device or of the heating assembly preferably assume a (total) heating capacity within the range of 1 to 100 KW, preferably between 2 and 20 KW, and can assume an area of several 100 cm², for example 200 cm². Heating elements are preferably operated by a direct current in the high-voltage range, i.e. in the range from approximately 100 to 1,000 volts (V). In particular, high voltages of this type can be provided in electric or hybrid vehicles, for example in passenger cars, at values up to the order of 500 V or higher, e.g. up to 800 V or higher, or in utility vehicles such as buses or HGVs at values up to the order of 100 V or higher. A heating device having a heating assembly according to the invention can thus be described as a high-voltage heating device.

It is hereby observed that the electric heating assembly or electric heating device according to the aspects and embodiments described herein, in particular, can be a fluid heating system. The term “fluid heating system” signifies that the heat transfer medium which flows through the heat exchanger of the heating assembly is a fluid. In particular, the medium can be a fluid coolant of the vehicle, which transports heat in the vehicle and can execute the discharge thereof at various locations. Additionally or alternatively, the fluid heating system can also be e.g. a constituent of a heat pump of a vehicle, such that the heat transfer medium e.g. can be or comprise a coolant of a heat pump. It can occur that the coolant is only present in a fully liquid form under specific conditions, and only in a temporary manner, or potentially never, and is otherwise also partially or entirely gaseous. This arrangement is nevertheless to be understood as a fluid heating system.

Further embodiments of the invention become apparent from the dependent claims.

### BRIEF DESCRIPTION OF THE DRAWINGS

Exemplary embodiments of the invention are described in greater detail hereinafter, with reference to the drawings. In the drawings:

FIG. 1 shows a schematic representation of one embodiment of a heating assembly according to the invention, in a perspective view, according to a first embodiment;

FIG. 2 shows a schematic representation of the embodiment according to FIG. 1, in an overhead view of the heating side of the heat-exchanger;

FIG. 3a shows a schematic representation of one embodiment of a heat-exchanger of a heating assembly according to the invention, in a perspective view of the heating side;

FIG. 3b shows a schematic representation of one embodiment of a heat-exchanger of a heating assembly according to the invention, in a perspective view of the heat transfer side;

FIG. 4 shows a schematic representation of the embodiment according to FIG. 1, in a perspective view, without the control board of the control unit;

FIG. 5 shows a schematic representation of the embodiment according to FIG. 1, in a perspective view, with the control board of the control unit in place;

FIG. 6 shows a schematic representation of the embodiment according to FIG. 1, in a sectional view;

FIG. 7 shows an enlarged schematic representation of the sectional view according to FIG. 6;

FIG. 8 shows a perspective view of a high-voltage electric heating device according to a second embodiment;

FIG. 9 shows an overhead view of an assembly of heating elements on a carrier board of a heat-exchanger of the heating device according to FIG. 8;

FIG. 10 shows a perspective view of the control module of the heating device according to FIG. 8, with a view of the outer second layer of an electrically insulating plastic material;

FIG. 11 shows the representation according to FIG. 10, but with the high-voltage connector unit removed;

FIG. 12 shows the representation according to FIG. 11, but with a view of the inner first layer of an electrically conductive plastic material, with the second layer removed;

FIG. 13 shows the representation according to FIG. 12, but with the first and second layers removed (only the base component and the cover are still visible);

FIG. 14 in an isolated representation, shows the positioning of punch grids, fixing screws, sheet metal inserts and the seal;

FIG. 15 shows a perspective view of the interior of the first module housing, according to the exemplary embodiment;

FIG. 16 shows a perspective view of the first module housing from the rear, with the second layer as the outer surface;

FIG. 17 shows the representation according to FIG. 16, but with the second layer removed, i.e. with a view of the inner first layer;

FIG. 18 shows the representation according to FIG. 15, with all electronic components, including the control device, in the installed state, but with the cover removed;

FIG. 19 shows the representation according to FIG. 18, but with the control device removed (circuit board and molding compound or filler material removed);

FIG. 20 shows a perspective view of the first module housing from below, with no punch grids;

FIG. 21 shows a perspective view of one of the punch grids;

FIG. 22 shows a further perspective view of the punch grid according to FIG. 21.

### DETAILED DESCRIPTION OF PREFERRED EXEMPLARY EMBODIMENTS

In the following description of preferred exemplary embodiments, it should be observed that the present disclosure of the various aspects is not limited to details of the layout and arrangement of components represented in the following description and in the figures. In practice, the exemplary embodiment can be implemented or executed in various ways. It should moreover be observed that the forms of expression and terminology employed herein are employed solely for the purposes of practical description, and are not to be considered by way of limitation by a person skilled in the art.

In the following description of the invention, the same reference symbols are employed for identical and identically functioning elements such that, in some cases, a repeated detailed description thereof is omitted, in the interests of preserving the conciseness and clarity of the representation.

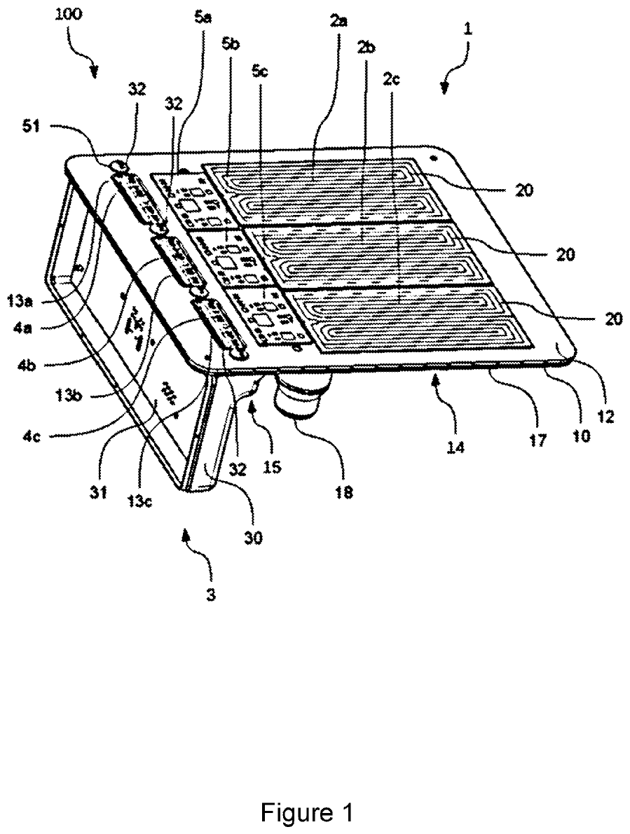

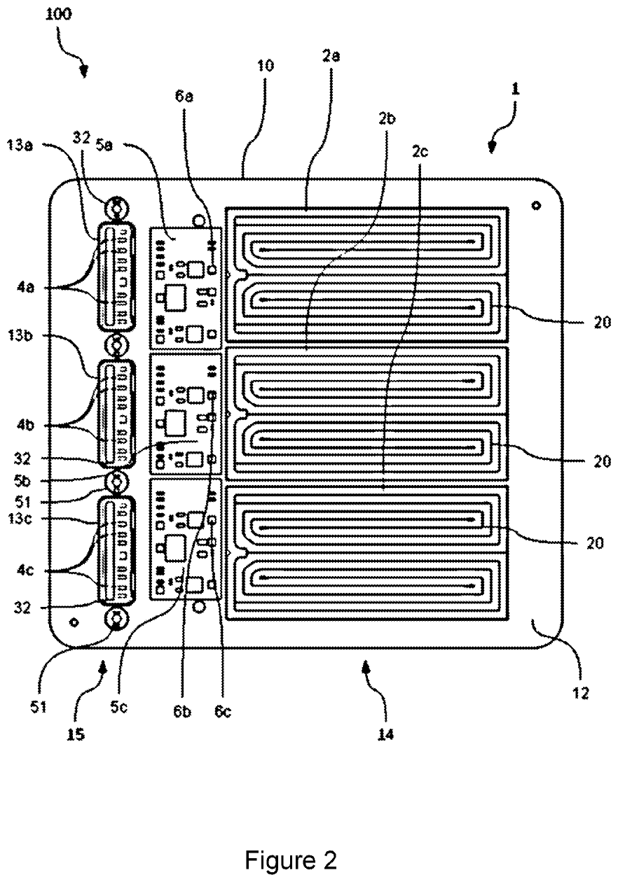

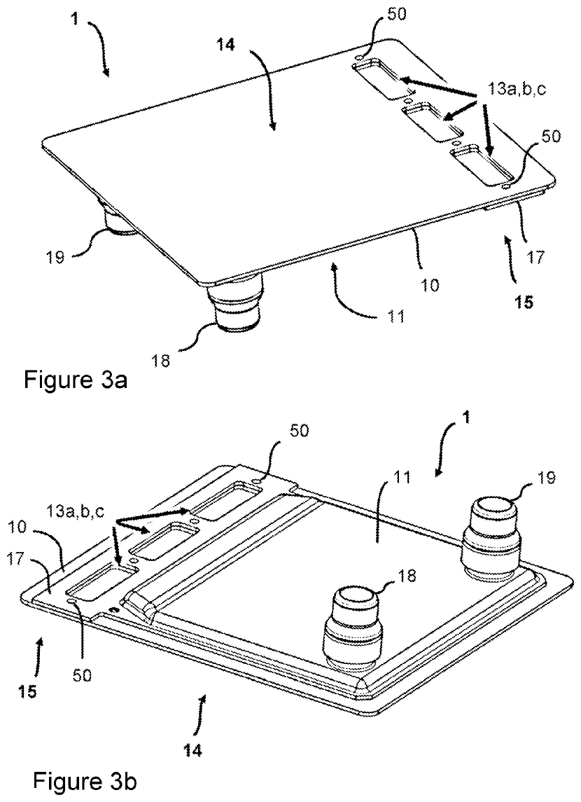

FIGS. 1, 2 and 4 to 7 show a first embodiment of a heating assembly 100 according to the invention, in various views. FIGS. 3a and 3b show the heat-exchanger 1 according to a further embodiment of the invention.

The heating assembly 100 according to the invention, or a corresponding heating device, preferably configured as a high-voltage heating device, are particularly appropriate for heating the vehicle interior or vehicle components in electric or hybrid vehicles. The heating assembly 100 comprises a heat-exchanger 1, multiple electric heating elements 2a, 2b, 2c, a control unit 3, and multiple electric connection lines 4a, 4b, 4c, which are connected to the control unit 3 and are employed for electrically contacting the heating elements 2a, 2b, 2c.

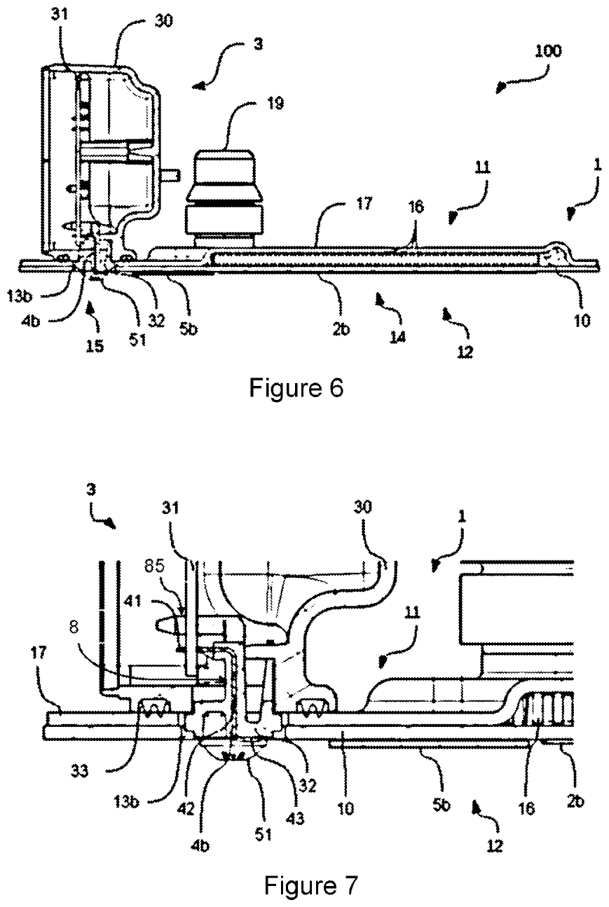

The heat exchanger 1 comprises a support body 10 for the heating elements 2a, 2b, 2c, which is made of aluminum and is of a plate-type design. The support body 10 has a heating side 12 having heating elements 2a, 2b, 2c, and an opposing heat transfer side 11. The support body 10 comprises multiple through-openings 13a, 13b, 13c from the heat transfer side to the heating side 12, through which connection lines 4a, 4b, 4c extend (see FIGS. 6 and 7). In the present case, three heating elements 2a, 2b, 2c having a rectangular basic shape are fitted to the surface of the support body 10 in a heat transfer section 14, in particular by adhesive bonding, wherein each heating element 2a, 2b, 2c is configured as a layer heating element, and comprises at least one spirally configured electric heating conductor 20 in a primary plane of extension of the heating elements 2a, 2b, 2c. The heating elements 2a, 2b, 2c may comprise a ceramic substrate which is adhesively bonded to the surface of the support body 10. In each case, a through-opening 13a, 13b or 13c and a corresponding group of connection lines 4a, 4b or. 4c are assigned to each heating element 2a, 2b and 2c.

The through-openings 13a, 13b, 13c with the connection lines 4a, 4b, 4c are arranged in a connecting section 15 of the support body 10. In the connecting section 15, externally to the heat transfer section 14, in the edge region of the support body 10, a control unit housing 30 of the superordinate control unit 3, having a control board 31, is arranged on the heat transfer side 11, and is connected to the support body 10, and thus to the heat-exchanger 1, by means of screws 51 which are fitted in the screw openings 50 (see FIGS. 3a and 3b).

Between the connection lines 4a, 4b, 4c and the heating elements 2a, 2b, 2c, in each case, a power switching unit 5a, 5b, 5c is arranged on the support body 10 which respectively comprises a temperature sensor 6a, 6b, 6c for monitoring the heating temperature of the respectively assigned heating element 2a, 2b, 2c and is employed for regulating the thermal and/or electric power of the respective heating element 2a, 2b, 2c. The temperature sensors 6a, 6b, 6c are respectively arranged on a circuit board of the power switching unit 5a, 5b, 5c.

The heat-exchanger 1, adjacently to the support body 10, comprises a top cover 17 which, in combination therewith, forms a heat-exchanger housing having a void therebetween, in which one or more flow ducts 16 for accommodating a throughflow of a heat transfer medium are configured. The top cover 17 forms an inflow connection 18 and an outflow connection 19 for the heat transfer medium which, according to one embodiment, may also be interchanged. As the inflow connection 18 and the outflow connection 19, together with the control unit 3 having the control unit housing 30, are arranged on the same side of the support body 10 or of the heat-exchanger 1, namely on the heat transfer side 11, the control unit housing 30 can be configured with a high degree of flexibility, in particular independently of the spatial arrangement and extent of the heating elements 2a, 2b, 2c and, optionally, in consideration of available structural space in the vehicle dictated by adjacent vehicle components. Moreover, the control unit housing 30 and the housing of the heat-exchanger 1 may be designed as self-contained closed units in the form of a modular structure having simplified interfaces. A saving of costs is achievable as a result.

In the connecting section 15 of the support body 10 which, in the present case, is configured as a rectangular support plate, the partially congruently configured top cover 17 and support body 10 are penetrated by the through openings 13a, 13b and 13c which, in each case, are entirely laterally enclosed, i.e. circumscribed (see FIGS. 3a and 3b). In the present case, a connecting region of the control unit housing 30 is embodied with three plastic inserts 32 which, upon the fitting thereof in combination with pre-fitted, for example embedded or overmolded connection lines 4a, 4b, 4c, are inserted into the through-openings 13a, 13b, 13c from the heat transfer side 11.

In FIGS. 6 and 7, a connection between the control unit 3 and the heating elements 2a, 2b, 2c or the power switching units 5a, 5b, 5c is illustrated in cross-section. In FIGS. 6 and 7, the respective center element 2b, 4b, 5b, 13b is illustrated in section. Between the surface of the top cover 17 and the connecting region of the control unit housing 30, a peripheral seal 33 is arranged in a peripheral groove, which seal, as a result of the arrangement according to the invention of the control unit 3 on the heat side 11, can be configured in a simple manner, with a comparatively short length. The primary plane of extension of the control board 31 is oriented perpendicularly to the primary plane of extension of the support body 10, of the power switching units 5a, 5b, 5c, and of the heating elements 2a, 2b, 2c.

The connection lines 4a, 4b, 4c are respectively embodied as printed conductors wherein, in each case, multiple connection lines are formed as a metallic punch grid having a two-fold angle and, in cross-section, exhibit a twice-bent Z-shape. In each case, line termination sections 41, 43 of the connection line 4a, 4b, 4c are oriented in parallel with the primary plane of extension of the support body 10, whereas the mid-section of the line 42 extends perpendicularly to the primary plane of extension of the support body 10, i.e. parallel to the primary plane of extension of the control unit housing 30, into the through-opening 13a, 13b, 13c. The line termination section 41 facing the control unit 3 is press-fitted to the control board 31. In the present case, the line termination section 43 facing the power switching unit 5a, 5b, 5c is configured with a bonding pad. The electrical connection between the line termination section 43 and the power switching units 5a, 5b, 5c can be executed by means of various conventional methods, in particular by soldering or bonding, e.g. by the ultrasonic bonding or laser bonding of bonding wires. Additionally, a press-fit between the line termination section 43 and the power switching units 5a, 5b and 5c is also possible. The heating assembly 100 according to the invention represented enables a high degree of flexibility in the design of the control unit housing 30, and can be manufactured in a simple and cost-effective manner.

A heating device may comprise, vis-à-vis the heating assembly described, additional components, for example a cover of the control unit housing 30 which, in FIG. 1, is represented with an open design, further housing parts such as, for example, a cover of the heating side 11 and of elements which are fitted thereto, such as e.g. the heating elements 2a, 2b, 2c, the power switching units 5a, 5b, 5c, with corresponding circuit boards, the through-openings 13a, 13b, 13c and the connection lines 4a, 4b, 4c which are routed therethrough, and electric terminals or infeed lines for the heat transfer medium.

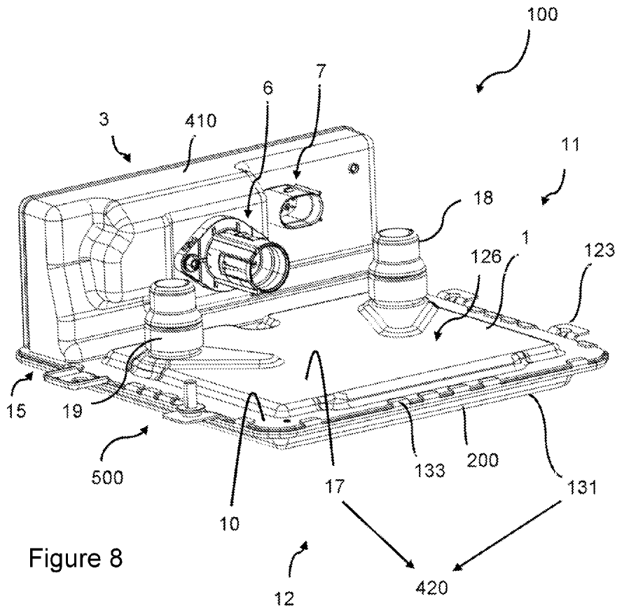

A second embodiment (see FIGS. 8 to 22) of a heating assembly 100 according to the present invention is depicted in FIG. 8, in a perspective view. As per the first embodiment, the heating assembly 100 is particularly intended for high-voltage fluid heating device for an electric or hybrid vehicle. It is hereby emphasized that such elements as are illustrated in the second embodiment according to FIGS. 8 to 22, which are, however, not visible in the first embodiment according to FIGS. 1 to 7 such as, for example, housing covers or details of the control unit 3 of the heat-exchanger 1, may also be implemented therein in a corresponding manner. In particular, the second embodiment can be combined with the first embodiment.

In the present embodiment, the heating assembly 100 is also essentially comprised of three components, namely a heat-exchanger 1, a heat conversion unit 200 having heating elements 2a, 2b, 2c, and a control module or control unit 3. The heat-exchanger 1 and the heat conversion unit 200 can be structurally combined to form a heat-exchanger module 500, to which the control unit 3 is fastened. The heat-exchanger module 500 assumes an essentially planar design, with a rectangular outline in an overhead view.

In FIG. 8, the heat-exchanger 1 is upwardly oriented, and comprises a deep-drawn top cover 17 which, in combination with a flat or planar support body 10, forms a likewise planar fluid chamber 126 with the one or more flow ducts 16 therein (in FIG. 8, the top cover 17 is arranged on top, and the support body 10 below). A flat circumferential edge of the top cover 17 is soldered or welded to the support body 10, for the lateral closure of the fluid chamber 126. As the top cover 17 according to FIG. 8 is arranged on the support body 10 (which is identified by an arrow only), the support body 10 is scarcely visible there. In the fluid chamber 126, an agitator is installed (which is not represented in the figures), which agitator stirs the fluid flowing through, supports the transfer of heat to the fluid, and is incorporated in the formation of the flow ducts 16 (see FIGS. 6 and 7). The fluid can be admitted to the fluid chamber 126 though an inflow connection 18 and, further to the heat-up thereof, discharged again via the outflow connection 19.

The heat conversion unit 200 comprises three heating elements 2a, 2b, 2c and—by way of distinction from the first embodiment, a single and common power switching unit 5, which is covered by a housing cover 131, which is fastened to the planar support body 10 (or to the edge of the top cover 17 which is soldered or welded thereto) by means of folded tabs 133. From the housing cover 131, in the plane defined by the heat-exchanger 1, fitting elements 123, which are configured integrally with the housing cover 131 and which enable a fitting in a vehicle, extend outwardly in a lateral direction.

The support body 10 is configured as a flat plate. In the specific exemplary embodiment illustrated, the top cover 17 of the heat-exchanger 1 and the housing cover 131 of the heat conversion unit 200, in combination, form a second module housing 420 for the heat-exchanger module 500.

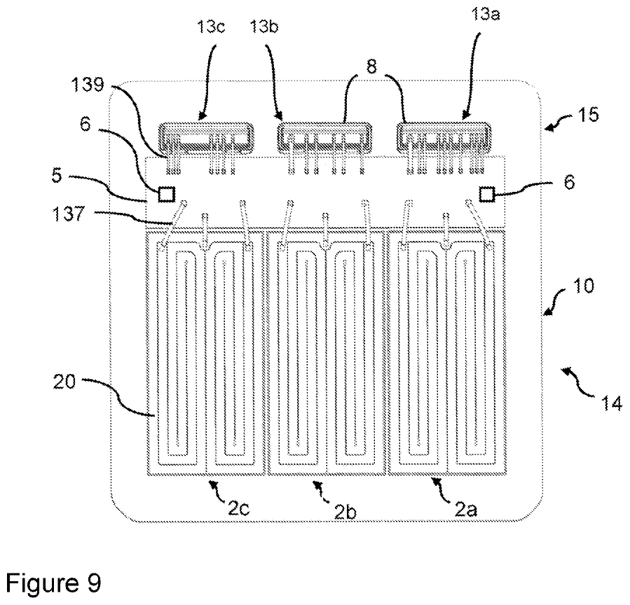

FIG. 9 shows the heating elements 2a, 2b, 2c and the power switching unit 5 in the fitted state thereof to the support body 10 of the heat-exchanger 1, in an overhead view. In the present embodiments, the heating elements 2a, 2b, 2c are configured in the form of a ceramic substrate (by way of support layer), for example of Al₂O₃, having a screen-printed heating conductor layer. The heating conductor layer is embodied as a metal plating of a resistance alloy, and constitutes the corresponding heating resistor. An interruption of insulation enables the structuring of elongated printed conductors 20. The ceramic substrate can be fitted to the planar support body 10 by means of an (unrepresented) thermally conductive bonding layer/adhesive.

The conductor tracks of the heating conductors 20, with respect to the resistance thereof (dictated by the thickness, length, width and specific sheet resistance of the material employed) are designed such that, at the operating voltage supplied in the high-voltage range, in the present embodiment, for example, 800 V, they are capable of generating the required heating power, preferably in the range of 5-13 KW inclusive.

The power switching unit 5 comprises a board or circuit board, and comprises a plurality of power switching elements, which are not represented separately here, for example IGBTs or power MOSFETs, by means of which the heating elements 2a, 2b, 2c can be operated, e.g. by PWM control. To this end, corresponding terminal pads of the conductor tracks of the heating conductors 20 are connected to the power switching elements on the power switching unit 5 by means of bonded connections 137.

The power switching unit 5 further comprises temperature sensors 6, which may detect a temperature of the support body 10 in the environment thereof, for the purposes of a regulation of the heating operation. The position thereof on the power switching unit 5, in the exemplary embodiment, corresponds to the inflow connection 18 and the outflow connection 19 on the reverse side of the support body 10 or of the heat-exchanger 1.

The power switching unit 5, by means of further bonded connections 139, is connected to respective terminals, which are configured on three punch grids 8 which are assigned to the respective heating elements 2a, 2b, 2c. The bonded connections 139 incorporate electrical conductors for the supply of (high-voltage) power, for the control of the power switching elements, and for communication with the temperature sensors. The punch grids 8 are arranged in through-openings 13a, 13b, 13c of the support body 10, which are configured in a connecting section 15 of the support body 10 for the fitting and attachment of the control unit 3. In FIG. 9, the screw openings 50, which are illustrated in relation to the first embodiment in FIGS. 3a and 3b, have been omitted, simply for the purpose of clarity, but are present in practice, in a corresponding position adjacently to the through-openings 13a, 13b, and 13c.

The control unit 3 comprises a control device 35, a first module housing 410 for the accommodation thereof, a high-voltage connector section 60 which is arranged therein, and a low-voltage connector section 70. The first module housing 410 assumes an approximately cuboid design. In the present case, the sections 60 and 70 are configured as flush-type socket outlets, into which couplings of a corresponding vehicle-side high-voltage connection and low-voltage connection can be plugged.

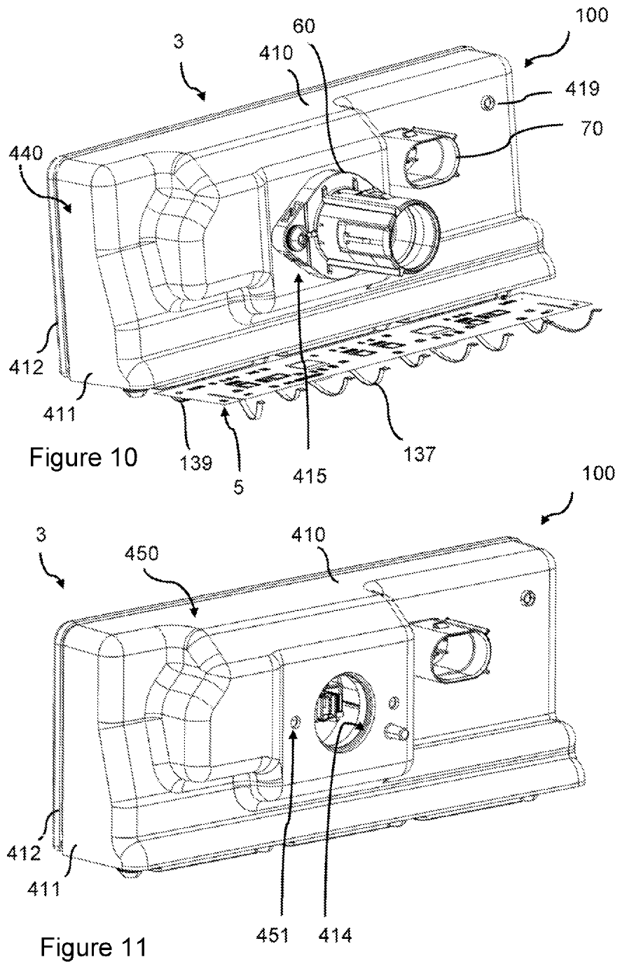

FIGS. 10 to 13 show the layout of the control unit 3 in greater detail, wherein, in the perspective views according to FIGS. 10-13, elements are successively omitted in each case, in order to permit a view of the interior of the control unit 3.

In FIG. 10, only the control unit 3 and the power switching unit 5 which is connected to the control device 35 are represented. It can be seen that the first module housing 410 comprises a base component 411 having a complex geometry, and an essentially planar 412 cover which closes an opening therein (which, in FIG. 10, is oriented to the rear), and is fastened thereto by means of ultrasonic welding. The base component 411 and the cover 412 define an interior space 413 (which is not represented in FIG. 10) in which the control device 35 is arranged. FIG. 10 moreover shows the bonded connections 137 from the heating elements 2a, 2b, 2c (which are omitted from FIG. 10) to the power switching unit 5 and, to some extent, the further bonded connections 139 from the power switching unit 5 to the punch grids 8 which, in turn, are connected to the control device 35.

In FIG. 10, a pressure-equalizing opening 419 is further represented, which connects an external environment to the interior space 413 of the first module housing 410. On the inner side at this location, a Gore-Tex membrane 491 is fitted (e.g. by ultrasonic welding), in order to prevent any ingress of moisture, c.f. FIG. 15 (which represents only the housing with the pressure-equalizing opening 419, which other elements omitted) and FIG. 19 (showing the membrane 491).

FIG. 11 shows the same view as FIG. 10, but with the high-voltage connector section 60 omitted. An opening 414 can thus be seen for the high-voltage connector section 60 which is to be inserted therein and secured by means of screws 415, and which is configured as an independent component.

The first module housing 410 is substantially comprised of a two-component plastics material. In particular, the first module housing 410 comprises an inner first layer 440 and a second outer layer 450. In FIGS. 10 and 11, the view is directed towards the outer surface of the first module housing, such that the second outer layer 450 can be seen. The second outer layer 450 is formed of an electrically insulating plastic. In particular, this is a glass fiber-reinforced thermoplastic material, for example PPS. The proportion (mass) of glass fibers in the material is preferably 40%.

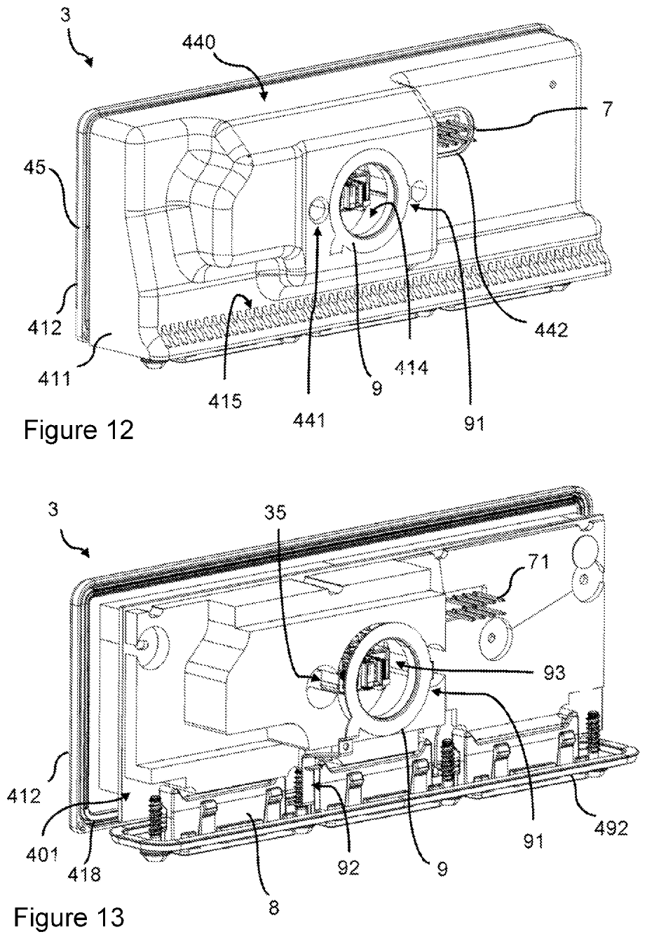

FIG. 12 shows the same perspective view of the first module housing 410 as FIG. 10 or 11, but with the second layer 450 removed, such that a view of the inner first layer 440 of an electrically conductive plastic material is enabled. The plastic material is a carbon fiber-reinforced thermoplastic material. The proportion (mass) of carbon fibers is preferably 40%. Here again, for example, the thermoplastic material is PPS, such that both layers assume similar, and thus compatible thermal properties. PPS is flameproof, and is thus particularly appropriate for employment in a heating device.

For the production of the first module housing 410, the two plastic material compounds are injection-molded in a directly temporally sequential manner. Firstly, the plastics material of the first layer 440 is injection-molded, and thereafter, provided that the temperature is still somewhat in excess of 100 degrees, a this is withdrawn using the turntable, and the plastic material is applied by spraying to form the second layer. The temperature ensures that an effective bond is achieved, but that no mutual fusion and mixture of materials is generated. In order to further improve mutual adhesion, and thus ensure long-term integrity, as shown in FIG. 12, a corrugation 415, which is molded into the first layer 440 during injection-molding can be seen, which is also correspondingly mirrored in the second layer 450 (not represented) which is applied thereto by spraying.

It can further be seen in FIG. 12 that the first layer 440 does not extend into a section 442 in which the low-voltage connector section 70 is configured. Conversely, this section is occupied by the second layer 450, such that the low-voltage connector section 70 is configured as an integrated element in the first module housing 410 (rather than a component which is to be fitted subsequently). As can be seen in the perspective view of the interior space 413 of the first module housing 410 in FIG. 12, the pins 71 of the low-voltage connector section 70 extend directly through the second layer 450, and are thus mutually isolated.

It can also be seen in FIG. 12 that, at the location where, in FIG. 11, self-tapping screws 415 for the attachment of the high-voltage connector section 60 (see FIG. 10) respectively form a comparatively small hole 451 in the second layer 450, a cut-out is also executed in the first layer, c.f. the larger holes 441 in FIG. 12. It is thus ensured that, via the screws 415 no high-voltage potential reaches the surface, the sufficiently rapid decay of which cannot be achieved, on the grounds of the material of the first layer 440.

Moreover, in FIG. 12, around the opening 414 for the high-voltage connector section 60, a recess is formed in the first layer 440, in which a metal ring 91 of a sheet metal insert 9 is embedded, which is employed for shielding in the region of the opening 414, if the high-voltage connector section 60 is inserted therein, and heating operation is in progress. By the integration of the sheet metal insert in the two-component plastic material, the base component 411 is thus comprised of at least a three-component material.

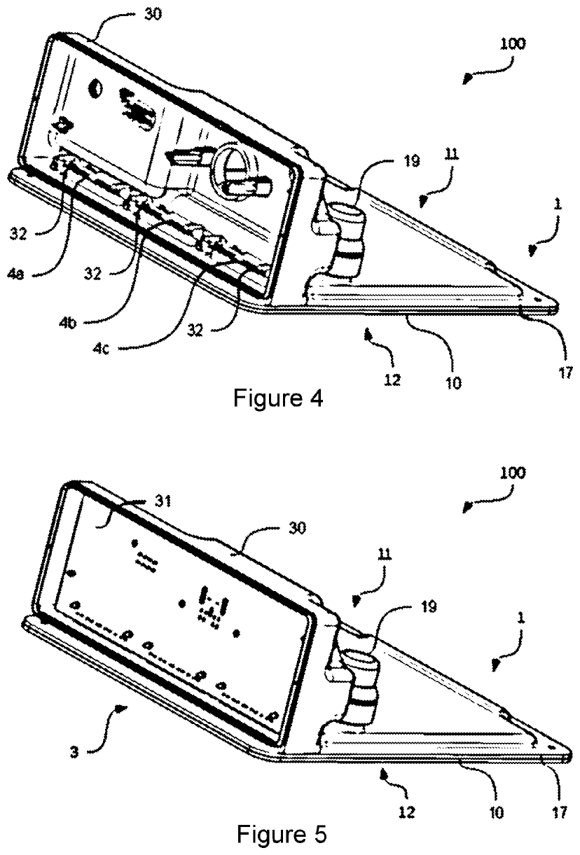

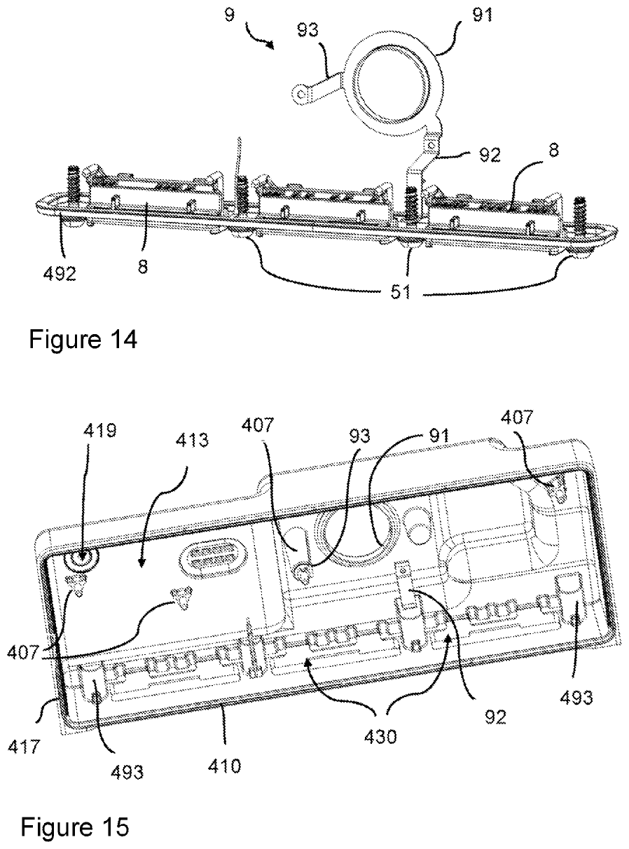

The sheet metal insert 9 further has a first metal conductor 92 and a second metal conductor 93, which can best be seen in FIG. 14, and which are also at least partially embedded in the first layer 440. The first metal conductor 92 extends from the metal ring 91 to a terminal on the support body 10, which is formed by one of four fixing screws 51 for fastening the control unit 3 to the support body 10. In the support body 10, to this end, at a corresponding position, screw openings 50 are configured, as can be seen e.g. in an analogous manner to the first embodiment in FIGS. 3 and 4. The second metal conductor 93 extends from the metal ring 91 to a terminal on the control board 31 of the control device 35. The metal ring 91 is thus maintained securely at a ground potential. FIG. 15 partially shows surfaces of the sheet metal insert 9 which are revealed in the inner first layer 440, facing the interior space 413.

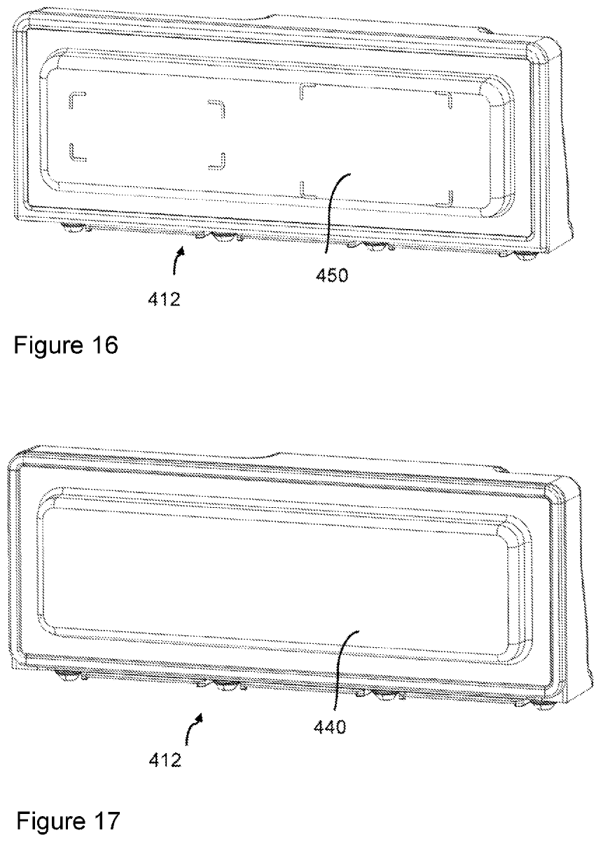

FIGS. 16 and 17 show the control module or control unit 3 from the reverse side, i.e. in particular the cover 412 of the module housing 410. In FIG. 16, the view illustrated is directed towards the outer second layer 450, which also forms the outer surface and, in FIG. 17, a view of the inner first layer 440 is revealed (the second layer in FIG. 10 is omitted). The cover 412 is irreversibly attached to the base component 411 by means of ultrasonic welding, for which purpose a groove 418 can be provided in the cover 412 (see FIG. 13), into which a circumferential lug 417 (see FIG. 15) of the base component 411 is inserted and welded.

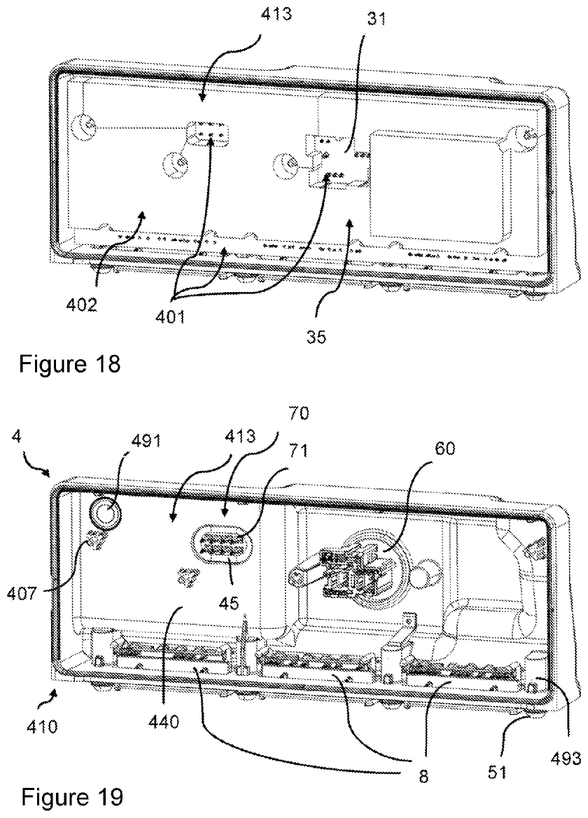

The control device 35 can be seen most clearly in FIG. 18. It is configured by a control board 31 having electronic modules which are arranged thereon, in particular one or more (unrepresented) microcontrollers. A molding compound 402 stabilizes and protects the control device 35 (i.e. the control board 31) in the interior space 413 of the first module housing 410. In FIG. 15, four positioning pins 407 are represented, which extend from the first module housing 410 (as an integrally configured element thereof) into the interior space 413 and, in the installed state, extend through (unrepresented) holes in the control board 31 and are secured thereto by hot caulking, such that the control board 31 is securely positioned and supported in the interior space 413.

The above-mentioned punch grids 8 are represented in FIGS. 13 and 14, and in greater detail in FIGS. 21 and 22. The punch grids are each correspondingly comprised of connection lines 4a, 4b, 4c which are stamped from sheet metal and respectively embedded in a plastic insert 32. The connection lines 4a, 4b, 4c connect corresponding contacts on the control board 31 which embodies the control device 35. Relative positioning is achieved by means of dome-shaped positioning pins 85, which engage or are fitted in corresponding holes (by press-fitting) which are configured in the control board 31 (not represented).

The punch grids 8 are spatially arranged in respectively corresponding apertures 430, which are configured in a lower region of the first module housing 410, as can be seen in FIGS. 8 and 13. In the assembled state, the apertures 430 of the first module housing 410 and the through-openings 13 in the support body 10 are mutually oriented, such that the punch grids 8 extend through both and are secured in position.

As represented in FIGS. 21 and 22, the punch grids 8 comprise connection lines 4a, 4b, 4c, having terminals at both ends. First terminals or line termination sections 41 are employed for connecting bonded connections 139, by means of which the electrical connection with the power switching unit 5 is achieved. The opposing second terminals or line termination sections 43 are configured with a pin-type design and, in the assembled state, are fitted (soldered) to contacts on the control board 31 using THT (through-hole technology), and are thus bonded to the control device 35. Mid-sections 42 of the connection lines 4a, 4b, 4c are essentially covered by the plastic insert 32. As per the first embodiment, by means of the preferably two-fold angling of the connection lines 4a, 4b, 4c shown in FIGS. 21 and 22, a Z-shaped design is assumed in a lateral cross-section. In particular, the line termination sections 41, 43 of the respective connection line 4a, 4b, 4c extend in a parallel direction to a primary plane of extension of the preferably plate-type support body 10, whereas the midsection of the line 42, which is embedded in the plastic insert, extends perpendicularly to the primary plane of extension of the support body 10.

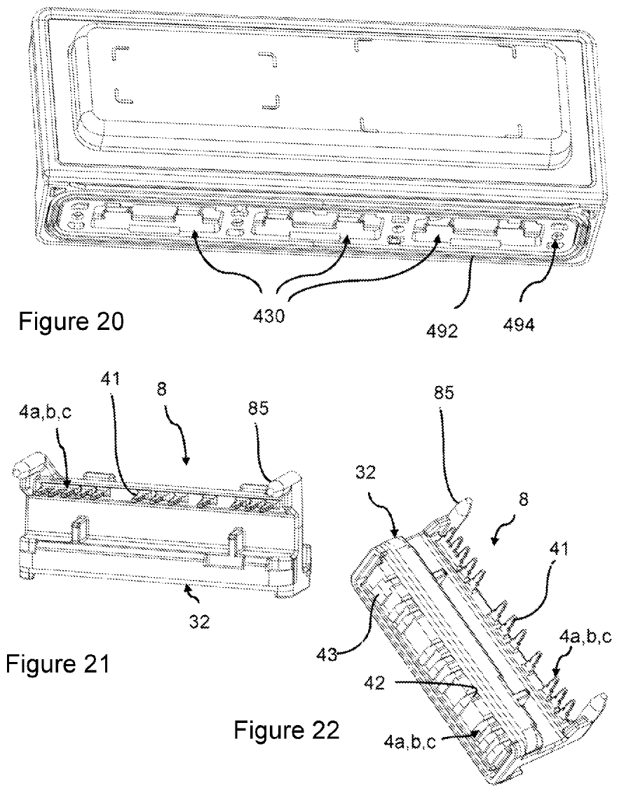

In FIG. 20, it is shown that, on the underside of the first module housing 410, adjacently to the apertures 430 for the punch grids 8 in the region of four wall reinforcements 493 (c.f. FIG. 19) in the first module housing 410, respective holes 494 are introduced by means of self-tapping fastening screws 51, which are represented in their position relative to the module housing according to FIGS. 13 and 14. In FIGS. 13 and 14, and in FIG. 20, a seal 492 can also be seen, which surrounds the through-openings 13a, 13b, 13c or the aperture 430, and thus protects the interior space 413 of the first module housing 410, and an interior space of the second module housing 420 which accommodates the power switching unit 5 and the heating elements 2a, 2b, 2c, against the ingress of moisture.

For assembly, the fixing screws 51 are inserted through corresponding screw openings 50 (which are not represented in FIGS. 8 to 22, but which are also implemented in the present embodiment, in a manner corresponding to the first embodiment in FIGS. 3 and 4) into the support body 10 and screwed into the wall reinforcements 493 represented in FIG. 19. The seal 492 is applied between the mutually facing surfaces of the support body 10 and the first module housing 410, or is molded into a groove which is provided in the first module housing 410, and is secured thereto by press-fitting. In particular, the seal 492 can advantageously be molded directly onto the base component 411 by spray application. According to this variant, the base component 411, on the grounds of the incorporation of two different plastics, the sheet metal insert and the seal, is thus comprised of at least a four-component material.

It is to be noted that all the above-mentioned features of the invention, considered in isolation and in any technically appropriate combination, and particularly the details represented in the drawings, are included in scope of the invention.

List of reference symbols

| | |
|---|---|
| 1 | Heat-exchanger |
| 2a, 2b, 2c | Heating element |
| 3 | Control unit |
| 4a, 4b, 4c | Connection line (e.g. in punch grid) |
| 5, 5a, 5b, 5c | Power switching unit |
| 6a, 6b, 6c | Temperature sensor |
| 8 | Punch grid |
| 9 | Sheet metal insert |
| 10 | Support body |
| 11 | Heat transfer side |
| 12 | Heating side |
| 13a, 13b, 13c | Through-opening |
| 14 | Heat transfer section |
| 15 | Connecting section |
| 16 | Flow duct |
| 17 | Top cover |
| 18 | Inflow connection |
| 19 | Outflow connection |
| 20 | Heating conductor |
| 30 | Control unit housing (=first module housing) |
| 31 | Control board |
| 32 | Plastic insert for punch grid |
| 33 | Seal |
| 35 | Control device |
| 41, 43 | Line termination section |
| 42 | Mid-section of line |
| 50 | Screw opening |
| 51 | Screw |
| 60 | High-voltage connector section |
| 70 | Low-voltage connector section |
| 81 | Terminals for control device |
| 83 | Terminals for bonded connection |
| 85 | Dome-shaped positioning pins |
| 91 | Metal ring |
| 92 | First metal conductor |
| 93 | Second metal conductor |
| 100 | Heating assembly |
| 123 | Fitting element |
| 126 | Fluid chamber |
| 131 | Housing cover |
| 133 | Tab |
| 137 | Bonded connection |
| 139 | Further bonded connection |
| 200 | Heat conversion unit |
| 402 | Molding compound |
| 407 | Positioning pins |
| 410 | First module housing |
| 411 | Base component |
| 412 | Cover |
| 413 | Interior space |
| 414 | Opening for high-voltage connector section |
| 415 | Corrugation |
| 417 | Lug |
| 418 | Groove |
| 419 | Pressure-equalizing opening |
| 420 | Second module housing |
| 430 | Aperture (in first module housing) |
| 440 | First layer of electrically conductive plastic |
| | material |
| 441 | Holes in first layer |
| 442 | Removed section in first layer |
| 443 | Cut-out for metal ring in first layer |
| 450 | Second layer of electrically insulating plastic |
| | material |
| 491 | Gore-Tex membrane |
| 492 | Seal (between control module and support plate) |
| 493 | Reinforcement (module housing) |
| 494 | Screw hole (module housing) |
| 500 | Heat-exchanger module |

1. A heating assembly for a vehicle, comprising:
a heat-exchanger, having a support body, for an in particular planar, electric heating element, wherein the support body, that is in particular of a plate-type, has a heating side and a heat transfer side, which is arranged opposite thereto;
at least one electric heating element, which is attached to the heating side of the support body;
a control unit for the at least one heating element; and
at least one electric connection line, which is connected to the control unit, for supplying power to the heating element;
wherein the support body comprises at least one through-opening from the heat transfer side to the heating side, through which the connection line extends.

2. The heating assembly as claimed in claim 1,
wherein the control unit, which is preferably configured for controlling multiple heating elements comprises a control unit housing, for accommodating a control board, which is arranged on the heat transfer side of the support body.

3. The heating assembly as claimed in claim 1,
wherein the control unit and at least one of: an inflow connection and an outflow connection for a heat transfer medium are arranged on the same side of the support body, on the heat transfer side.

4. The heating assembly as claimed in claim 1,
wherein the support body comprises a heat transfer section in the region of the at least one heating element, and a connecting section which is external to the heat transfer section, wherein the at least one through-opening is formed in the connecting section.

5. The heating assembly as claimed in claim 1,
wherein the heat-exchanger, on the heat transfer side of the support body, comprises at least one flow duct to accommodate a throughflow of a heat transfer medium.

6. The heating assembly as claimed in claim 1,
wherein the heat-exchanger comprises a top cover which, in combination with the support body, forms a void for accommodating a throughflow of a heat transfer medium and which, forms at least one flow duct.

7. The heating assembly as claimed in claim 1,
wherein the through-opening penetrates the top cover and the support body in the region of the connecting section of the support body.

8. The heating assembly as claimed in claim 1,
wherein, on the heating side of the support body, at least one power switching unit is fitted for regulating the power of the heating element, wherein the power switching unit is preferably arranged between the through-opening and the heating element and, is electrically connected by means of the connection line.

9. The heating assembly as claimed in claim 1,
wherein the power switching unit is connected to a temperature sensor which is arranged on the heating side of the support body, preferably on a circuit board of the power switching unit.

10. The heating assembly as claimed in claim 1,
wherein at least one of: multiple heating elements are fitted to the heating side of the support body and the support body comprises multiple through-openings, wherein one through-opening is assigned to each heating element.

11. The heating assembly as claimed in claim 1,
wherein a power switching unit is assigned to each through-opening, and is respectively connected to a connection line wherein one power switching unit is assigned to each heating element.

12. The heating assembly as claimed in claim 1,
wherein the primary plane of extension of the control board of the control unit is arranged at an angle of at least 45° to at least one of: the primary plane of extension of the power switching unit and/or of the heating element.

13. The heating assembly as claimed in claim 1,
wherein the connection line is embodied as a printed conductor which is partially enclosed by a plastic insert, in the form of a bent punch grid, wherein the outer contour of the plastic insert is adapted to the inner contour of the through-opening.

14. The heating assembly as claimed in claim 1,
wherein the connection line incorporates a preferably two-fold angle, wherein the line termination sections of the connection line extend in a parallel arrangement to the primary plane of extension of the plate-type support body and a mid-section of the line extends perpendicularly to the primary plane of extension of the support body.

15. The heating assembly as claimed in claim 1, wherein:
in the control unit housing, at least one aperture is configured for the feedthrough of an electrical connection between a control board which forms a control device in the control unit housing and the power switching unit for switching the electric heating element; and
wherein one punch grid respectively is arranged in the at least one aperture, together with the connection lines embedded in a plastic insert, wherein the connection lines are connected with corresponding contacts on the control board which forms the control device.

16. The heating assembly as claimed in claim 15, wherein:
the punch grid extends through the aperture and the through-opening into an interior space of the control unit housing, where it is secured by at least one positioning means, particularly by a positioning pin, to the control board which forms the control device.

17. A high-voltage heating device for an electric or hybrid vehicle, comprising:
at least one heating assembly (100) comprising:
a heat-exchanger, having a support body, for an in particular planar, electric heating element, wherein the support body, that is in particular of a plate-type, has a heating side and a heat transfer side, which is arranged opposite thereto;
at least one electric heating element-which is attached to the heating side of the support body;
a control unit for the at least one heating element; and
at least one electric connection line, which is connected to the control unit, for supplying power to the heating element;
wherein the support body comprises at least one through-opening from the heat transfer side to the heating side, through which the connection line extends.
